(19) United States
(12) Patent Application Publication
(10) Pub. No.: US 2016/0178052 A1
(43) Pub. Date: Jun. 23, 2016

(54) MINIMAL LINE PRESSURE DISTURBANCE PUMP SWITCHING VALVE

(71) Applicant: GM Global Technology Operations LLC, Detroit, MI (US)

(72) Inventors: Philip C. Lundberg, Keego Harbor, MI (US); Steven P. Moorman, Dexter, MI (US)

(21) Appl. No.: 14/577,449

(22) Filed: Dec. 19, 2014

(51) Int. Cl. F16H 61/00; F04C 14/24; F04C 2/344; F16K 11/07; F16K 31/06

(52) U.S. Cl. CPC F16H 61/0025; F16K 11/07; F16K 31/0613; F04C 2/3448; F04C 14/24

(57) ABSTRACT

A variable force solenoid valve and a switching valve provide minimal line pressure disturbance in the output of an engine driven balanced hydraulic pump when switching between full flow and half flow in an automatic transmission. The variable force solenoid receives a signal from a transmission control module (TCM) or other electronic controller and provides controlled, pressurized hydraulic fluid (transmission oil) to a modulating binary switching or control valve that in a first position provides fluid flow from both outlet ports of the hydraulic pump to the line pressure regulator, modulates to reduce pressure and flow by returning a portion of the flow from one output port to an inlet port to match the requirements of the transmission between the first position and a second position and, in the second position, returns all flow from one of the pump outlet ports back to a suction or inlet port of the pump

### FIELD

The present disclosure relates to hydraulic pump controls for continuously variable transmissions and more particularly to a modulating control valve and associated control program for minimizing line pressure disturbances when switching from full pump flow mode to half pump flow mode in a motor vehicle transmission such as a planetary gear or continuously variable transmission.

### BACKGROUND

The statements in this section merely provide background information related to the present disclosure and may or may not constitute prior art.

Binary or two mode operation of the hydraulic pump of a motor vehicle transmission is a means to improve fuel economy over a transmission with a single mode pump. Unfortunately, the transition from high pump flow operation, to lower pump flow operation, or vice versa, is generally accompanied by a transient pressure disturbance that affects the hydraulic system and, in some instances, can interfere with the operation of the transmission controls.

A consequence of this flow transition pressure disturbance and possible control interference is that control schemes are modified to compensate for any dip in the line pressure. Line pressure must be commanded to a higher level during flow transition in order to ensure proper operation of the transmission hardware. Increasing the line pressure has a negative effect on fuel economy. The larger the magnitude of pressure disturbance, the more that the line pressure must be increased to compensate, and the larger the fuel economy penalty.

Accordingly, it would be desirable if the transient accompanying a shift from one operating mode to another of a binary mode transmission pump could be minimized—not only because the overall operation of the transmission would be improved but also because the line pressure command can be optimized for fuel economy. The present invention is so directed.

### SUMMARY

The present invention provides improved transmission performance when switching between modes of a binary mode pump in a motor vehicle automatic transmission. The invention utilizes a variable force solenoid (VFS) valve and a binary switching valve with an engine driven balanced hydraulic vane pump and a line pressure regulator. The variable force solenoid receives a signal from a transmission control module (TCM) or other electronic controller such as an engine control module (ECM) and provides controlled, pressurized hydraulic fluid (transmission oil) to a modulating binary switching or control valve that in a first position provides fluid flow from both outlet ports of the hydraulic pump to the line pressure regulator, modulates to reduce pressure and flow by returning a portion of the flow from one outlet port to an inlet port to match the requirements of the transmission between the first position and a second position and, in the second position, returns all flow from one of the pump outlet ports back to a suction or inlet port of the pump, thereby reducing power consumption of the pump and more closely matching the pressure and flow output of the pump to the current requirements of the transmission.

Thus it is an aspect of the present invention to provide an engine driven balanced hydraulic pump and modulating binary control valve for a motor vehicle automatic transmission.

It is a further aspect of the present invention to provide an engine driven balanced hydraulic pump, variable force solenoid and modulating binary control valve for a motor vehicle automatic transmission.

It is a still further aspect of the present invention to provide an engine driven balanced hydraulic pump, variable force solenoid and modulating binary control valve for a motor vehicle automatic transmission which provides a controlled transition between full pump flow and pressure and one half pump flow and pressure.

It is a still further aspect of the present invention to provide an engine driven balanced hydraulic pump, variable force solenoid and modulating binary control valve for a motor vehicle automatic transmission which provides a controlled transition between full pump flow and pressure and one half pump flow and pressure by modulating the volume of fluid returned from one outlet port to an inlet port.

It is a further aspect of the present invention to provide an engine driven balanced hydraulic pump, variable force solenoid and modulating binary control valve for a motor vehicle automatic transmission which provides minimal line pressure disturbance when switching between full pump flow and half pump flow.

Further aspects, advantages and areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic view of the associated components and fluid flow paths of a balanced binary pump control valve for use with a motor vehicle automatic transmission according to the present invention;

FIG. 2 is an enlarged, fragmentary view illustrating the chamfers on the lands of the spool of the binary pump control valve; and

FIGS. 3A, 3B and 3C are sequential views of the binary pump control valve illustrating a first position with full (both outlets active) flow, an intermediate, modulating position where the binary valve is moving between the first position and a second position and a second position with one-half flow (one outlet active) with the flow of one outlet returned to an inlet, respectively.

### DETAILED DESCRIPTION

The following description is merely exemplary in nature and is not intended to limit the present disclosure, application, or uses.

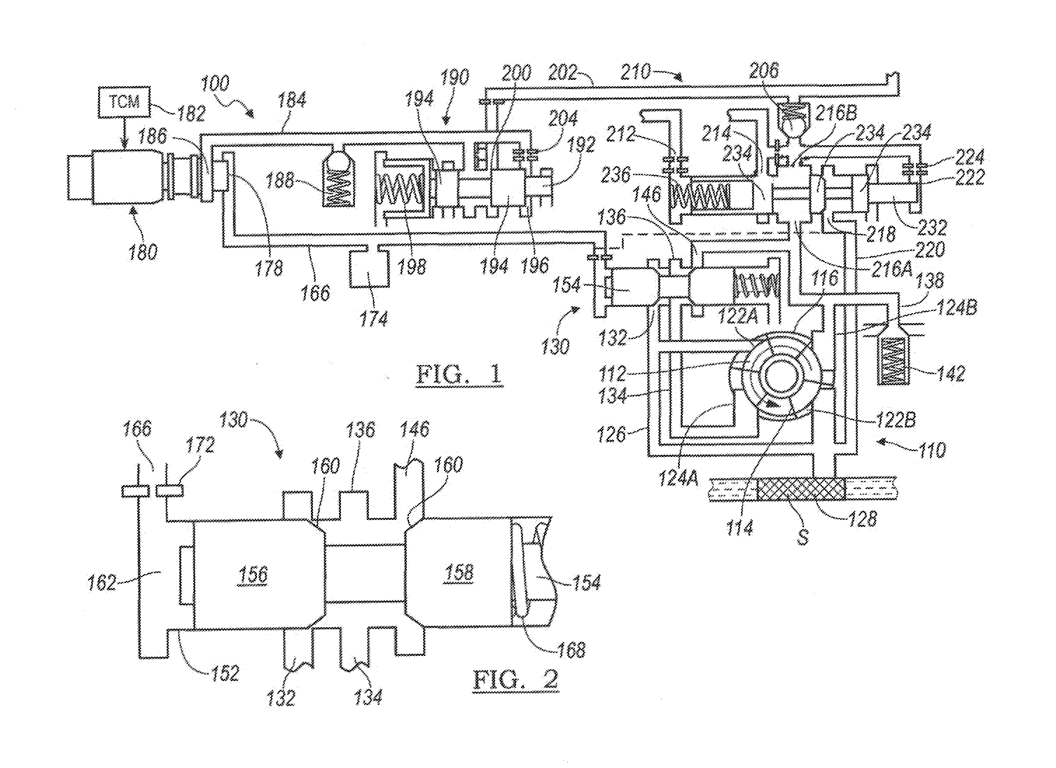

With reference to FIG. 1, a balanced pump, a modulating binary pump control valve and associated components of a system for achieving minimal line pressure disturbance in a hydraulic supply line to a continuously variable transmission are illustrated and generally designated by the reference number 100. The system 100 includes a balanced hydraulic fluid (transmission oil) pump 110 which is driven by a prime mover such as an internal combustion engine (not illustrated). The balanced hydraulic fluid pump 110 includes a circular rotor 112 having a plurality of freely radially slidable vanes 114 both disposed in a oval pumping chamber 116 defining two diametrically opposed inlet or suction ports 122A and 122B and, associated respectively therewith, two diametrically opposed outlet or supply ports 124A and 124B. The inlet or suction ports 122A and 122B are connected through a fluid suction line 126 to a filter 128 disposed in the sump S of the transmission and withdraw hydraulic fluid (transmission oil) therefrom. The fluid line 126 also communicates with an inlet port 132 of a binary pump control valve 130.

The outlet or supply port 124A of the balanced pump 110 communicates with a hydraulic line 134 which connects to an inlet port 136 of the binary pump control valve 130. The outlet or supply port 1248 of the balanced pump 110 communicates with a hydraulic line 138 which connects to a pressure relief valve 142, the input of a line pressure regulator 144 and an outlet port 146 of the binary pump control valve 130.

Referring now to FIGS. 1 and 2, the binary pump control valve 130 includes a cylindrical housing 152 which slidably receives a spool 154 having a first, left land 156 and a second, right land 158 as viewed in FIGS. 1 and 2. As illustrated in FIG. 2, the edges of the opposed faces of the lands 156 and 158 include chamfers 160 which improve the modulating control of hydraulic fluid flow in the binary pump control valve 130. To the left of the first, left land 156 between its end and the housing 152 is a chamber 162 that is supplied with hydraulic fluid under variable pressure from the hydraulic line 166. To the right of the second, right land 158 between its end and the housing 152 is disposed a compression spring 168 which biases the valve spool 154 to the left in FIG. 1.

The hydraulic line 166 may include a flow restricting orifice 172 and a pressure accumulator valve 174 and is supplied with hydraulic fluid from the output port 178 of a variable force solenoid (VFS) valve 180. The variable force solenoid valve 180 is configured to and operates as a normally high valve, that is, when little or no current is supplied to the solenoid valve 180 from a transmission control module (TCM) 182, engine control module (ECM) or similar electronic controller or microprocessor, the hydraulic fluid output in the hydraulic line 166 is high or equal to the fluid pressure in a supply line 184 which appears at an inlet port 186 of the variable force solenoid valve 180. Conversely, when the signal supplied by the transmission control module 182 is high or near maximum, the hydraulic fluid output in the hydraulic line 166 is zero or a preselected minimum value. It will be appreciated, however, that with suitable changes to the programs and/or circuitry of the transmission control module 182 or other controller, the variable force solenoid valve 180 may be configured to operate as a normally low valve.

The supply line 184 which also provides pressurized hydraulic fluid to various other solenoid control valves and actuators (not illustrated) in the system 100 includes an actuator feed blow off or pressure relief valve 188. Hydraulic fluid pressure in the supply line 184 is controlled by an actuator feed servo pressure regulator 190. The actuator feed pressure regulator 190 includes a spool 192 with lands 194, an input or pressure chamber 196 which communicates with the supply line 184, a return compression spring 198 and an inlet port 200 which communicates with a line pressure hydraulic line 202. Flow restricting orifices 204 reside in the hydraulic lines 184 and 202 proximate the actuator feed pressure regulator 190.

Hydraulic fluid in the line pressure hydraulic line 202 is supplied through a one-way (check) valve 206 from a line pressure regulator 210. The line pressure regulator 210 includes a first control port 212 which receives hydraulic fluid from a line pressure control (not illustrated), a port 214, an inlet port 216A which receives hydraulic fluid directly from the outlet port 124A of the balanced pump 110 which is opposite an outlet port 216B which communicates with the input of the check valve 206. The line pressure regulator 210 also includes a second outlet port 218 which communicates with the suction ports 122A and 122B of the balanced pump 110 through a hydraulic line 220 and the suction line 126. The line pressure regulator 210 further includes a second control port 222 which receives a hydraulic fluid through flow restricting orifices 224 from the outlet port 216B. Also included in the line pressure regulator 210 is a valve spool 232 having three lands 234 and a return compression spring 236 which biases the spool 232 to the right in FIG. 1.

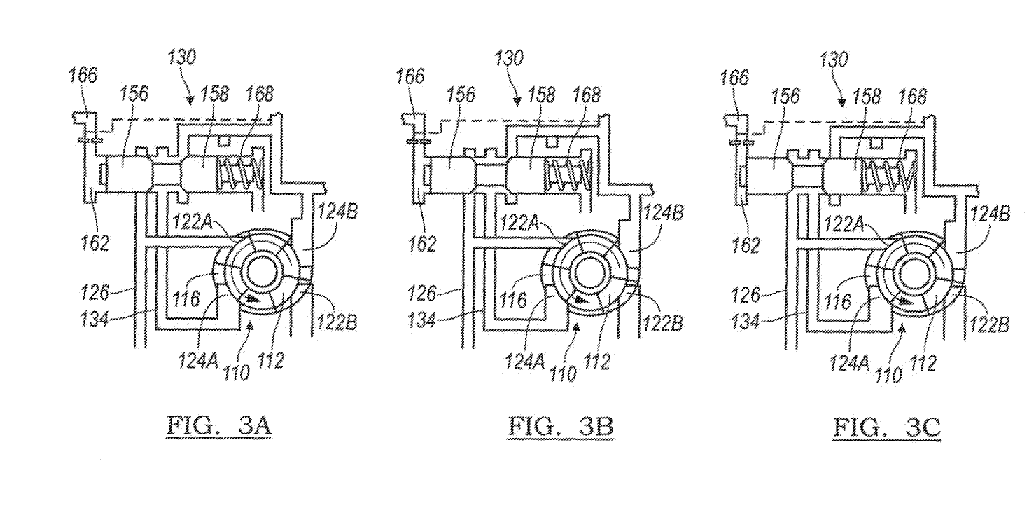

Referring now to FIGS. 3A, 3B and 3C, operation of the system 100 and particularly the binary pump control valve 130 is well illustrated and will be described. The binary pump control valve 130 includes the spool 154, the position of which is accurately controlled by the output of the variable force solenoid valve 180. This accurate control of the position of the spool 154 provides controlled transition between full pump flow utilizing both pump outlets 124A and 124B which is illustrated in FIG. 3A and one-half pump flow where the fluid from the first outlet 124A is returned through the hydraulic line 126 to the first inlet port 122A which is illustrated in FIG. 3C. FIG. 3B illustrates an intermediate position of the spool 154 wherein the portion of returned flow varies with the position of the spool 154.

It will be appreciated that the chamfers 160 (illustrated in FIG. 2) on the opposed ends of the lands 156 and 158 of the spool 154 assist in the accurate, proportioning control of direct and return hydraulic fluid flow by providing improved metering relative to square edged lands. Additionally, the axial spacing between the ends of the lands 158 and 158 relative to the spacing between the ports 132, 136 and 146 affects the extent of closure of one port relative to the extent of opening of another and this spacing may be adjusted to carefully tune the performance of the system 100. Such improved control ensures that there is minimal line pressure disturbance and smooth and improved performance of a continuously variable transmission. Moreover, since the transition provides little or no line pressure disturbance, it can be undertaken whenever operating conditions require it, thereby reducing power consumption of the pump and very closely matching the pressure and flow output of the pump to the current requirements of the transmission.

The description of the invention is merely exemplary in nature and variations that do not depart from the gist of the invention are intended to be within the scope of the invention. Such variations are not to be regarded as a departure from the spirit and scope of the invention.

What is claimed is:

1. A control system for a binary pump control valve comprising, in combination,
a variable force solenoid valve having an electrical input, a fluid inlet and fluid outlet,
a balanced hydraulic pump having first and second inlets associated with respective first and second outlets,
a binary pump control valve having a spool, a control port communicating with said fluid outlet of said variable force solenoid valve, an inlet port communicating with said first outlet of said hydraulic pump, a first outlet port communicating with said first inlet of said pump and a second outlet port communicating with said second outlet of said pump,
wherein a position of said spool relative to said ports of said control valve is controlled by the variable force solenoid and said position controls direct and return flow of said hydraulic pump.

2. The control system of claim 1 further including an actuator feed pressure regulator having an output communicating with said fluid inlet of said variable force solenoid valve.

3. The control system of claim 1 wherein said hydraulic pump is engine driven.

4. The control system of claim 1 further including a transmission control module having at least one output, said output connected to said electrical input of said variable force solenoid valve.

5. The control system of claim 1 further including a filter disposed in a sump and communicating with said first and second inlets of said hydraulic pump.

6. The control system of claim 1 wherein said balanced hydraulic pump includes a rotor supporting a plurality of radially sliding vanes disposed in an oval pumping chamber.

7. The control system of claim 1 further including a line pressure regulator having an inlet port communicating with said second outlet port of said pump control valve and said second outlet of said pump.

8. A control system for a binary pump control valve for an automatic transmission comprising, in combination,
a transmission control module having an electrical output,
a variable force solenoid valve controlled by said electrical output and having a fluid inlet and fluid outlet,
a balanced hydraulic pump having first and second inlets associated with respective first and second outlets,
a binary pump control valve having a spool, a pair of lands, a control port communicating with said fluid outlet of said variable force solenoid valve, an inlet port communicating with said first outlet of said hydraulic pump, a first outlet port communicating with said first inlet of said pump and a second outlet port communicating with said second outlet of said pump,
wherein the position of said spool of said control valve is controlled by said variable force solenoid.

9. The control system of claim 8 wherein said first outlet port of said pump control valve also communicates with said second inlet of said hydraulic pump.

10. The control system of claim 8 further including an actuator feed pressure regulator having an output communicating with said fluid inlet of said variable force solenoid valve.

11. The control system of claim 8 further including a filter disposed in a sump and communicating with said first and second inlets of said hydraulic pump.

12. The control system of claim 8 wherein said balanced hydraulic pump includes a rotor supporting a plurality of radially sliding vanes disposed in an oval pumping chamber.

13. The control system of claim 8 further including a line pressure regulator having an inlet port communicating with said second outlet port of said pump control valve and said second outlet of said pump.

14. The control system of claim 8 wherein said opposed faces of said pair of lands of said spool include chamfers

15. A control system for a binary pump control valve for an automatic transmission comprising, in combination,
a transmission control module having an electrical output,
a variable force solenoid valve controlled by said electrical output and having a fluid inlet and fluid outlet,
an engine driven balanced hydraulic pump having a first inlet associated with a first outlet and a second inlet associated with a second outlet,
a binary pump control valve having a spool and a pair of spaced apart lands, a control port communicating with said fluid outlet of said variable force solenoid valve, an inlet port communicating with said first outlet of said hydraulic pump, a first outlet port communicating with said first inlet of said pump and a second outlet port communicating with said second outlet of said pump,
wherein a position of said spool controls direct and return flow from said pump.

16. The control system of claim 15 wherein said opposed faces of said pair of spaced apart lands of said spool include chamfers.

17. The control system of claim 15 wherein said first outlet port of said pump control valve also communicates with said second inlet of said hydraulic pump.

18. The control system of claim 15 further including an actuator feed pressure regulator having an output communicating with said fluid inlet of said variable force solenoid valve.

19. The control system of claim 15 further including a line pressure regulator having an inlet port communicating with said second outlet port of said pump control valve and said second outlet of said pump.
